(19) United States
(12) Patent Application Publication
(10) Pub. No.: US 2012/0166793 A1
(43) Pub. Date: Jun. 28, 2012

(54) APPARATUS AND METHOD FOR SHARING AND USING COMMENT ON CONTENT IN DISTRIBUTED NETWORK SYSTEM

(76) Inventor: Dae Youb KIM, Seoul (KR)

(21) Appl. No.: 13/169,481

(22) Filed: Jun. 27, 2011

(30) Foreign Application Priority Data
Dec. 22, 2010 (KR) 10-2010-0132310

(51) Int. Cl. H04L 9/00

(52) U.S. Cl. 713/150

(57) ABSTRACT

An apparatus and method for sharing and using content, and a comment on the content, via a distributed network are provided. A comment sharing apparatus for sharing a comment on content may generate the comment on the content, may set an access control policy for the comment, may generate a comment key based on the access control policy, may encrypt the comment using the comment key, and may share the encrypted comment via the distributed network. In response to the access control policy being accessible by only a content sharer sharing the content, the comment sharing apparatus may encrypt the comment key using a public key of the content sharer, and may share the encrypted comment key. Additionally, in response to the access control policy being accessible by only a content sharer sharing the content and a comment sharer sharing the comment, the comment sharing apparatus may encrypt the comment key using a public key of the content sharer and using a public key of the comment sharer, and may share the encrypted comment keys.

CROSS-REFERENCE TO RELATED APPLICATION(S)

This application claims the benefit under 35 U.S.C. §119(a) of Korean Patent Application No. 10-2010-0132310, filed on Dec. 22, 2010, in the Korean Intellectual Property Office, the entire disclosure of which is incorporated herein by reference for all purposes.

### BACKGROUND

1. Field The following description relates to an apparatus and method for sharing and using content, and a comment on the content via a distributed network.

2. Description of Related Art

As personal content services and social networking services that use a central system increase, users are increasingly sharing their personal content with a specified or unspecified number of people. Most services which allow the sharing of personal content provide interactive services that enable the sharing of the personal content provided by a user together with an opinion, remark, etc., of another user pertaining to the shared content in the form of a comment.

In a distributed network system based on a cache-and-forward architecture, intermediate nodes used in networking may selectively cache content, and may forward the cached content. Accordingly, the distributed network system may include any efficient future networking technologies for transmission of content. A distributed networking technology may enable content to be efficiently shared, without a need to operate a central system.

In other words, since intermediate nodes cache and forward content, the distributed networking technology may receive content from neighboring nodes caching the content, as well as a node corresponding to a designated destination address, in response to a request for the content. Accordingly, the distributed networking technology may be efficient.

However, since content is forwarded from intermediate nodes, the distributed networking technology requires a networking protocol having a different form from a networking protocol with a structure of a source address/destination address.

### SUMMARY

In one general aspect, an apparatus for using a comment on a content includes a content request unit to receive a comment request command, to verify a content name included in the received comment request command, to request a distributed network to transmit content corresponding to the content name, and an access control list (ACL) of the content, to acquire the content and the ACL of the content from the distributed network, and to verify a right for the content by checking the ACL of the content, a content key acquisition unit to acquire a content key in response to the right for the content existing, the content key being used to decrypt the content, a comment request unit to request the distributed network to transmit the comment on the content, and an ACL of the comment, to receive the comment and the ACL of the comment from the distributed network, to verify an access control policy by checking a header of the comment, and to verify a right for the comment by checking the ACL of the comment, the comment corresponding to at least one condition included in the comment request command, a comment key acquisition unit to acquire a comment key based on the access control policy, in response to the right for the comment existing, the comment key being used to decrypt the comment, and a decryption unit to decrypt the content using the content key, and to decrypt the comment using the comment key.

In response to the access control policy being accessible by only a user having a right to read and write the content, the comment key acquisition unit may acquire the content key as the comment key.

In response to the access control policy being accessible by only a content sharer sharing the content, and in response to the content sharer requesting the comment, the comment key acquisition unit may request the distributed network to transmit a comment key encrypted with a public key of the content sharer, may acquire the encrypted comment key from the distributed network, and may decrypt the encrypted comment key using a private key of the content sharer, to obtain the comment key.

In response to the access control policy being accessible by only a content sharer sharing the content and a comment sharer sharing the comment, and in response to the content sharer requesting the comment, the comment key acquisition unit may request the distributed network to transmit a comment key encrypted with a public key of the content sharer, may acquire the encrypted comment key from the distributed network, and may decrypt the encrypted comment key using a private key of the content sharer, to obtain the comment key.

In response to the access control policy being accessible by only a content sharer sharing the content and a comment sharer sharing the comment, and in response to the comment sharer requesting the comment, the comment key acquisition unit may request the distributed network to transmit a comment key encrypted with a public key of the comment sharer, may acquire the encrypted comment key from the distributed network, and may decrypt the encrypted comment key using a private key of the comment sharer, to obtain the comment key.

The header of the comment may include a name of the content, a content tag, a comment tag, and version information. The content tag may include information regarding whether a comment is permissible, and information regarding whether identification information of a comment sharer is included. The comment tag may include information indicating a start of comment-related information, information regarding whether a sub-comment is permissible, information regarding whether identification information of a sub-comment sharer is included, access control policy information, or any combination thereof. The version information may include time information regarding a time at which the comment is shared.

The header of the comment may further include the identification information of the comment sharer sharing the comment.

The comment request command may include a command to request the content, and all comments corresponding to the content, a command to request the content, and a comment of a designated comment sharer among the comments, a command to request the content, and a comment corresponding to a designated time slot among the comments, and a command to request the content, a comment of a designated comment sharer in a designated time slot among the comments, or any combination thereof.

In another general aspect, an apparatus for sharing a comment on content includes a content using unit to request a distributed network to transmit the content, and to use the content, a comment generation unit to generate the comment on the content, in response to the comment on the content being permitted, a policy setting unit to set an access control policy for the comment, a comment key generation unit to generate a comment key based on the access control policy, an encryption unit to encrypt the comment using the comment key, and to share the encrypted comment via the distributed network, and a comment ACL generation unit to generate an ACL of the comment, and to share the generated ACL via the distributed network.

The comment generation unit may verify a content tag included in a header of the content, and may determine whether the comment is permissible.

The policy setting unit may set the access control policy based on a preset criterion, or set the access control policy in response to an input of a user.

The policy setting unit may insert the access control policy into a header of the comment.

In response to the access control policy being accessible by only a user having a right to read and write the content, the comment key generation unit may use, as the comment key, a content key used to decrypt the content.

In response to the access control policy being accessible by only a content sharer sharing the content, the comment key generation unit may generate the comment key using a random number, may encrypt the comment key using a public key of the content sharer, and may share the encrypted comment key via the distributed network.

In response to the access control policy being accessible by only a content sharer sharing the content and a comment sharer sharing the comment, the comment key generation unit may generate the comment key using a random number, may encrypt the comment key using a public key of the content sharer and using a public key of the comment sharer, and may share the encrypted comment keys via the distributed network.

The comment may include a name of the content, a content tag, a comment tag, and version information. The content tag may include information regarding whether a comment is permissible, and information regarding whether identification information of a comment sharer is included. The comment tag may include information indicating a start of comment-related information, information regarding whether a sub-comment is permissible, information regarding whether identification information of a sub-comment sharer is included, access control policy information, or any combination thereof. The version information may include time information regarding a time at which the comment is shared.

The header of the comment may further include the identification information of the comment sharer sharing the comment.

In another general aspect, a method of using a comment on content in a comment using apparatus includes verifying a content name in response to a comment request command, the content name being included in the received comment request command, requesting a distributed network to transmit the content corresponding to the content name, and an ACL of the content, and acquiring the content and the ACL of the content from the distributed network, verifying a right for the content by checking the ACL of the content, acquiring a content key in response to the right for the content existing, the content key being used to decrypt the content, decrypting the content using the content key, requesting the distributed network to transmit a comment on the content, and an ACL of the comment, and receiving the comment and the ACL of the comment from the distributed network, the comment corresponding to at least one condition included in the comment request command, verifying an access control policy by checking a header of the comment, and verifying a right for the comment by checking the ACL of the comment, acquiring a comment key based on the access control policy, in response to the right for the comment existing, the comment key being used to decrypt the comment, and decrypting the comment using the comment key.

In another general aspect, a method of sharing a comment on content in a comment sharing apparatus includes requesting a distributed network to transmit the content, and using the content, generating the comment on the content, in response to the comment on the content being permitted, setting an access control policy for the comment, generating a comment key based on the access control policy, encrypting the comment using the comment key, to obtain the encrypted comment, generating an ACL of the comment, and sharing the encrypted comment, and the generated ACL via the distributed network.

The generating of the comment key may include using, as the comment key, a content key used to decrypt the content, in response to the access control policy being accessible by only a user having a right to read and write the content.

The generating of the comment key may include, in response to the access control policy being accessible by only a content sharer sharing the content, generating the comment key using a random number, encrypting the comment key using a public key of the content sharer, and sharing the encrypted comment key via the distributed network.

The generating of the comment key may include, in response to the access control policy being accessible by only a content sharer sharing the content and a comment sharer sharing the comment, generating the comment key using a random number, encrypting the comment key using a public key of the content sharer and using a public key of the comment sharer, and sharing the encrypted comment keys via the distributed network.

In another general aspect, there is provided a method of generating and sharing content, the method including generating the content, setting an access control policy of the content, encrypting the content, generating an access control list (ACL) of the content, and sharing the encrypted content and the generated ACL.

The encrypting of the content may include generating a content key and encrypting the content using the content key.

The content key may be used as a comment key to indicate whether a comment is allowed on the content.

The ACL may indicate whether a user has a right to read, write, and/or delete the content.

The method may further include generating a header for the content, wherein the header indicates whether a comment is permissible.

Other features and aspects may be apparent from the following detailed description, the drawings, and the claims.

### BRIEF DESCRIPTION OF THE DRAWINGS

FIG. 1 illustrates an example of a distributed network system that shares content, and a comment on the content.

FIG. 2 is a block diagram illustrating an example configuration of the content sharing apparatus of FIG. 1.

FIG. 3 is a block diagram illustrating an example configuration of the comment using apparatus of FIG. 1.

FIG. 4 is a block diagram illustrating an example configuration of the comment sharing apparatus of FIG. 1.

FIG. 5 illustrates an example of a header of content.

FIG. 6 illustrates an example of a header of a comment.

FIG. 7 illustrates another example of a header of a comment.

FIG. 8 is a flowchart illustrating an example of a method of generating content and sharing the content in the content sharing apparatus of FIG. 1.

FIG. 9 is a flowchart illustrating an example of a method of requesting content, and a comment on the content, and using the content and comment in the comment using apparatus of FIG. 1.

FIG. 10 is a flowchart illustrating an example of a method of generating a comment on content and sharing the comment in the comment sharing apparatus of FIG. 1.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. Accordingly, various changes, modifications, and equivalents of the systems, apparatuses, and/or methods described herein will be suggested to those of ordinary skill in the art. Also, description of well-known functions and constructions may be omitted for increased clarity and conciseness.

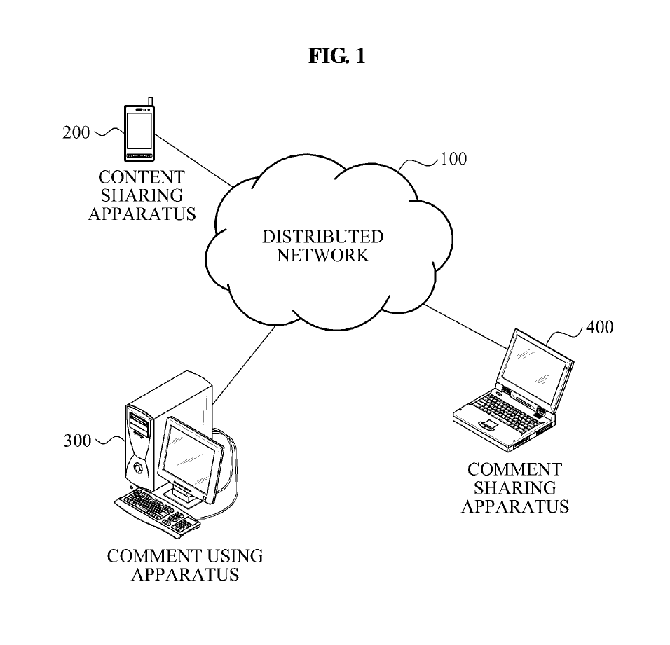

FIG. 1 illustrates an example of a distributed network system that shares content, and a comment on the content.

Referring to FIG. 1, the example distributed network system may include a distributed network 100, a content sharing apparatus 200, a comment using apparatus 300, and a comment sharing apparatus 400. It is apparent that more and various types of devices may be included in the distributed network system, but the example system is simplified for ease of description. Further, while the content sharing apparatus 200 is illustrated as a mobile terminal, the comment using apparatus 300 is illustrated as a desktop computer, and the comment sharing apparatus 400 is illustrated as a laptop computer, these designations are merely for the purpose of this example. Any of these devices, as well as other types of apparatuses, may be exchangeable regarding the purposes described in this example.

The content sharing apparatus 200 may generate content, and may share the content via the distributed network 100.

The comment sharing apparatus 400 may generate a comment on, or associated with, regarding, etc., the content, and may share the comment via the distributed network 100.

The comment using apparatus 300 may use the content and the comment that are shared via the distributed network 100.

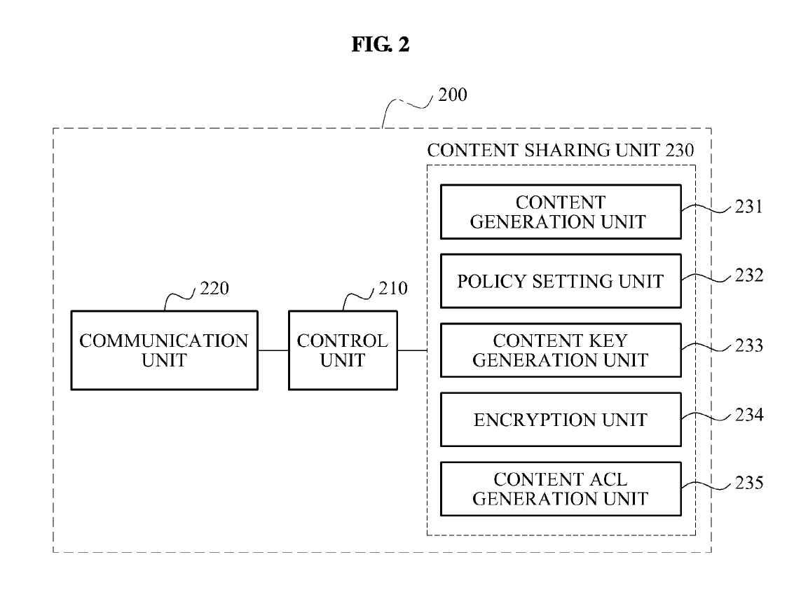

The content sharing apparatus 200 and the comment sharing apparatus 400 may share the generated content and the generated comment via the distributed network 100. In other words, content and a comment may be stored in apparatuses used to generate the content and the comment, and may be shared. Additionally, content and a comment may be stored in an optional node in the distributed network 100, and may be shared. In this example, a security problem in which a user without an access control right accesses the content or the comment may occur. Hereinafter, the content sharing apparatus 200, the comment using apparatus 300, and the comment sharing apparatus 400 that are used to solve such a security problem will be further described with reference to FIGS. 2 to 4.

FIG. 2 is a block diagram illustrating an example configuration of the content sharing apparatus 200 of FIG. 1.

Referring to FIG. 2, the example content sharing apparatus 200 may include a control unit 210, a communication unit 220, and a content sharing unit 230.

The communication unit 220 may perform wired or wireless communication with the distributed network 100, and may share content generated by the content sharing unit 230.

The content sharing unit 230 may generate content, may set an access control policy of the generated content, and may share the content so that only a user having a right for the content may access the content based on the set access control policy. The content sharing unit 230 may include a content generation unit 231, a policy setting unit 232, a content key generation unit 233, an encryption unit 234, and a content access control list (ACL) generation unit 235.

The content generation unit 231 may generate content.

The policy setting unit 232 may set the access control policy of the content, whether a comment is permissible, whether an identification (ID) of a commenter is represented, and the like. In this example, the ID of the commenter may be used to identify a user sharing the comment.

The content key generation unit 233 may generate a content key that may be used to encrypt the generated content. In this example, the content key may be set in advance to be open to a predetermined group or an individual, or may be recognized by only a user that generates the content key, or may be published to only a predetermined user after encryption, and so on.

The encryption unit 234 may encrypt the content using the content key, and may share the encrypted content via the distributed network 100.

The content ACL generation unit 235 may generate an ACL of the content, and may share the ACL of the content via the distributed network 100. As an example, the ACL of the content may be a list of users having access control rights for the content, and the access control rights may be classified into a read right, a write right, and a delete right. The delete right may be typically given to only a user that generates and shares content, but such a restriction is not necessary.

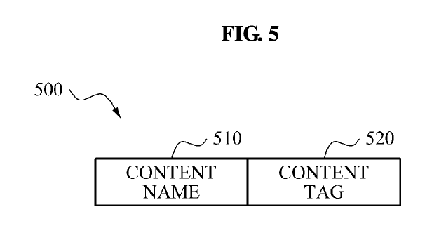

A header of the content generated by the content sharing unit 230 may be formed as illustrated in FIG. 5. FIG. 5 illustrates an example of a header of content.

Referring to FIG. 5, a header 500 of the content may include, for example, a content name 510 and a content tag 520. In this example, the content name 510 may indicate a name defined by a user that generates the content, and the content tag 520 may indicate whether a comment is permissible, and whether an ID of a commenter is represented, and so on. In this example, the ID of the commenter may be used to identify a user sharing the comment.

The control unit 210 may control an overall operation of the content sharing apparatus 200. Additionally, the control unit 210 may perform functions of the content generation unit 231, the policy setting unit 232, the content key generation unit 233, the encryption unit 234, and the content ACL generation unit 235. To individually describe the functions, the control unit 210, the content generation unit 231, the policy setting unit 232, the content key generation unit 233, the encryption unit 234, and the content ACL generation unit 235 are separately illustrated in FIG. 2. However, one or more of those functions may be performed by the control unit 210. Accordingly, the control unit 210 may include at least one processor configured to perform the functions of one or more of the content generation unit 231, the policy setting unit 232, the content key generation unit 233, the encryption unit 234, and the content ACL generation unit 235. Additionally, the control unit 210 may include at least one processor configured to perform a portion of one or more of the functions of the content generation unit 231, the policy setting unit 232, the content key generation unit 233, the encryption unit 234, and the content ACL generation unit 235.

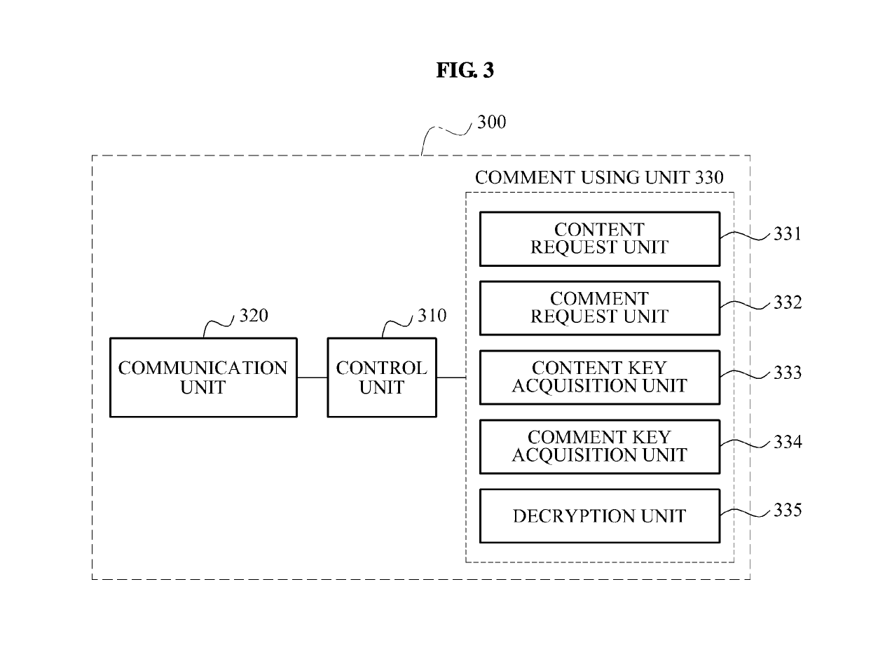

FIG. 3 is a block diagram illustrating an example configuration of the comment using apparatus 300 of FIG. 1.

Referring to FIG. 3, the comment using apparatus 300 may include a control unit 310, a communication unit 320, and a comment using unit 330.

The communication unit 320 may perform wired or wireless communication with the distributed network 100, and may receive shared content or a shared comment on the content from a plurality of nodes in the distributed network 100.

The comment using unit 330 may request the content and the comment on the content that are shared via the distributed network 100, and may use the content and the comment. The comment using unit 330 may include a content request unit 331, a comment request unit 332, a content key acquisition unit 333, a comment key acquisition unit 334, and a decryption unit 335.

In response to a comment request command being received, the content request unit 331 may verify a content name included in the received comment request command, may request the distributed network 100 to transmit the content corresponding to the content name, and an ACL of the content, and may acquire the content and the ACL of the content. Additionally, the content request unit 331 may verify an access right for the content by checking the ACL of the content.

The comment request unit 332 may request the distributed network 100 to transmit a comment on the content corresponding to at least one condition included in the comment request command, and to transmit an ACL of the comment, and may receive the comment and the ACL of the comment from the distributed network 100. Additionally, the comment request unit 332 may verify an access control policy by checking a header of the comment, and may verify an access right for the comment by checking the ACL of the comment.

In this example, the comment request command may include, for example a command to request the content and all comments corresponding to the content, a command to request the content and a comment of a designated comment sharer among the comments, a command to request the content and a comment corresponding to a designated time slot among the comments, a command to request the content and a comment of a designated comment sharer in a designated time slot among the comments, or the like, or any combination of these commands.

The content key acquisition unit 333 may acquire a content key in response to the access right for the content existing. In this example, the content key may be used to decrypt the content.

The comment key acquisition unit 334 may acquire a comment key based on the access control policy, in response to the access right for the comment existing. In this example, the comment key may be used to decrypt the comment.

In an example in which the access control policy is accessible by only a user having a right to read and write the content, sometimes referred to as an access right in this description, the comment key acquisition unit 334 may acquire the content key as the comment key.

In another example in which the access control policy is accessible by only a content sharer sharing the content, in response to the content sharer requesting the comment, the comment key acquisition unit 334 may request the distributed network 100 to transmit a comment key encrypted with a public key of the content sharer, may acquire the encrypted comment key from the distributed network 100, and may decrypt the encrypted comment key using a private key of the content sharer, to obtain the comment key.

In another example in which the access control policy is accessible by only a content sharer sharing the content and by a comment sharer sharing the comment, in response to the content sharer requesting the comment, the comment key acquisition unit 334 may request the distributed network 100 to transmit a comment key encrypted with a public key of the content sharer, may acquire the encrypted comment key from the distributed network 100, and may decrypt the encrypted comment key using a private key of the content sharer, to obtain the comment key.

In another example in which the access control policy is accessible by only a content sharer sharing the content and a comment sharer sharing the comment, in response to the comment sharer requesting the comment, the comment key acquisition unit 334 may request the distributed network 100 to transmit a comment key encrypted with a public key of the comment sharer, may acquire the encrypted comment key from the distributed network 100, and may decrypt the encrypted comment key using a private key of the comment sharer, to obtain the comment key.

The decryption unit 335 may decrypt the content using the content key, and may decrypt the comment using the comment key.

The control unit 310 may control an overall operation of the comment using apparatus 300. Additionally, the control unit 310 may perform functions of the content request unit 331, the comment request unit 332, the content key acquisition unit 333, the comment key acquisition unit 334, and the decryption unit 335. To individually describe the functions, the control unit 310, the content request unit 331, the comment request unit 332, the content key acquisition unit 333, the comment key acquisition unit 334, and the decryption unit 335 are separately illustrated in FIG. 3. However, one or more of those functions may be performed by the control unit 310. Accordingly, the control unit 310 may include at least one processor configured to perform one or more of the functions of the content request unit 331, the comment request unit 332, the content key acquisition unit 333, the comment key acquisition unit 334, and the decryption unit 335. Additionally, the control unit 310 may include at least one processor configured to perform a portion of one or more of the functions of the content request unit 331, the comment request unit 332, the content key acquisition unit 333, the comment key acquisition unit 334, and the decryption unit 335.

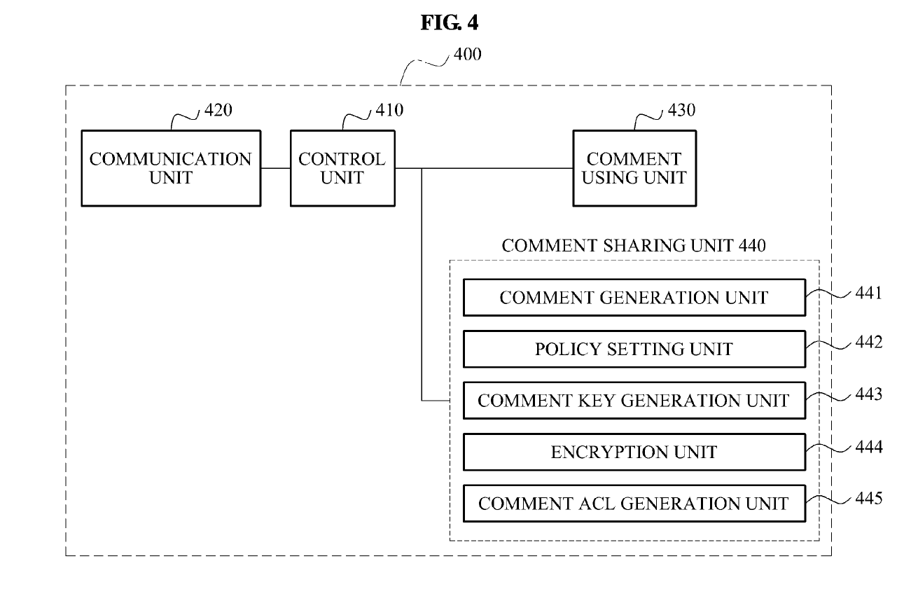

FIG. 4 is a block diagram illustrating an example configuration of the comment sharing apparatus 400 of FIG. 1.

Referring to FIG. 4, the comment sharing apparatus 400 may include a control unit 410, a communication unit 420, a comment using unit 430, and a comment sharing unit 440.

The communication unit 420 may perform wired or wireless communication with the distributed network 100, and may receive shared content or a shared comment on the content from a plurality of nodes of the distributed network 100. Additionally, the communication unit 420 may share a comment generated by the comment sharing unit 440.

The comment using unit 430 may request the content and the comment on the content that are shared via the distributed network 100, and may use the content and the comment. The comment using unit 430 may be configured similarly, or identically, to the comment using unit 330 of FIG. 3.

The comment sharing unit 440 may generate a comment on the content, may set an access control policy of the generated comment, and may share the comment so that only a user having an access right for the comment may access the comment based on the set access control policy. The comment sharing unit 440 may include a comment generation unit 441, a policy setting unit 442, a comment key generation unit 443, an encryption unit 444, and a comment ACL generation unit 445.

The comment generation unit 441 may verify a content tag included in a header of the content, and may determine whether a comment is permissible. In a case in which a comment is permitted, the comment generation unit 441 may generate a comment on the content.

The policy setting unit 442 may set the access control policy of the comment, whether a sub-comment is permissible, whether an ID of a commenter is represented, and the like. In this example, the ID of the commenter may be used to identify a user sharing the sub-comment. The access control policy of the comment may indicate a range of users permitted to access the comment. The policy setting unit 442 may either set the access control policy based on a preset criterion, or set the access control policy in response to an input of a user.

The comment key generation unit 443 may generate a comment key based on the access control policy.

In an example in which the access control policy is accessible by only a user having a right to read and write the content, the comment key generation unit 443 may use, as a comment key, a content key used to decrypt the content.

In another example in which the access control policy is accessible by only a content sharer sharing the content, the comment key generation unit 443 may generate the comment key using a random number. Additionally, the comment key generation unit 443 may encrypt the comment key using a public key of the content sharer, and may share the encrypted comment key via the distributed network 100.

In another example in which the access control policy is accessible by only a content sharer sharing the content and a comment sharer sharing the comment, the comment key generation unit 443 may generate the comment key using, for example, a random number. Additionally, the comment key generation unit 443 may encrypt the comment key using a public key of the content sharer and using a public key of the comment sharer, and may share the encrypted comment keys via the distributed network 100.

The encryption unit 444 may encrypt the comment using the comment key, and may share the encrypted comment via the distributed network 100.

The comment ACL generation unit 445 may generate an ACL of the comment, and may share the ACL of the comment via the distributed network 100. In this example, the ACL of the comment may be a list of users having access control rights for the comment, and the access control rights may be classified into a read right, a write right, and a delete right. The delete right may be typically given to only a user that generates and shares a comment and a user that generates and shares content corresponding to the comment. However, such a restriction is not necessary.

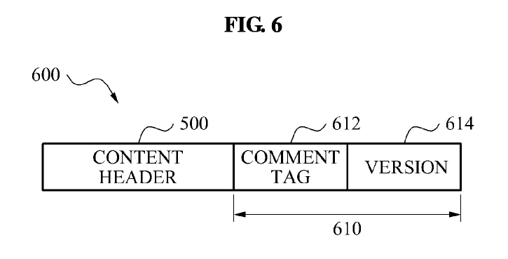

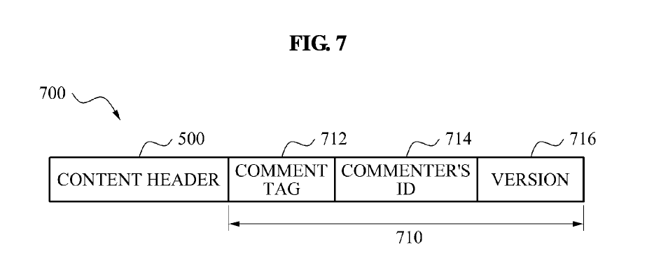

A header of the comment generated by the comment sharing unit 440 may be formed as illustrated in FIG. 6 or FIG. 7.

FIG. 6 illustrates an example of a header of a comment. Referring to FIG. 6, a header 600 of a comment may include the header 500 of FIG. 5, and a sub-header 610.

The header 500 may be included in the content corresponding to the comment.

The sub-header 610 may be a header with substantial information of the comment, and may include a comment tag 612 and a version indicator 614.

The comment tag 612 may include information indicating a start of comment-related information, information regarding whether a sub-comment is permissible, information regarding whether identification information of a sub-comment sharer is included, access control policy information, and the like, as well as any combination of those types of information. In this example, the information indicating the start of the comment-related information may indicate a start of the sub-header 610.

The version indicator 614 may include time information regarding a time at which the comment is shared.

FIG. 7 illustrates another example of a header of a comment. Referring to FIG. 7, a header 700 of a comment may include the header 500 of FIG. 5, and a sub-header 710.

The header 500 may be included in the content corresponding to the comment.

The sub-header 710 may be a header with substantial information of the comment, and may include a comment tag 712, a commenter's ID 714, and a version indicator 716.

The comment tag 712 may include information indicating a start of comment-related information, information regarding whether a sub-comment is permissible, information regarding whether identification information of a sub-comment sharer is included, access control policy information, and the like, as well as any combination of such information. In this example, the information indicating the start of the comment-related information may indicate a start of the sub-header 710.

The commenter's ID 714 may include identification information of a user that generates and shares a comment.

The version indicator 716 may include time information regarding a time at which the comment is shared.

The control unit 410 may control an overall operation of the comment sharing apparatus 400. Additionally, the control unit 410 may perform functions of the comment generation unit 441, the policy setting unit 442, the comment key generation unit 443, the encryption unit 444, and the comment ACL generation unit 445. To individually describe the functions, the control unit 410, the comment generation unit 441, the policy setting unit 442, the comment key generation unit 443, the encryption unit 444, and the comment ACL generation unit 445 are separately illustrated in FIG. 4. However, one or more of those functions may be performed by the control unit 410. The control unit 410 may include at least one processor configured to perform one or more of the functions of the comment generation unit 441, the policy setting unit 442, the comment key generation unit 443, the encryption unit 444, and the comment ACL generation unit 445. Additionally, the control unit 410 may include at least one processor configured to perform a portion of one or more of the functions of the comment generation unit 441, the policy setting unit 442, the comment key generation unit 443, the encryption unit 444, and the comment ACL generation unit 445.

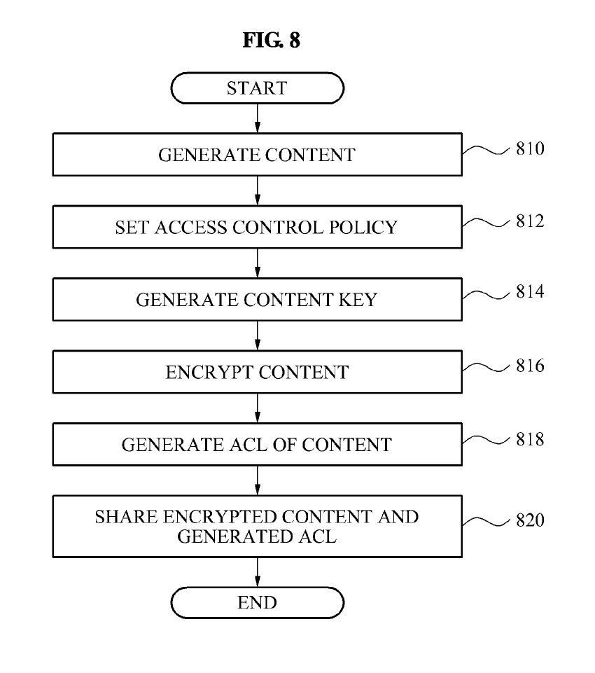

Hereinafter, a method of sharing and using a comment on content in a distributed network system configured as described above will be described with reference to FIGS. 8 to 10.

FIG. 8 is a flowchart illustrating an example of a method of generating content and sharing the content in the content sharing apparatus 200. Referring to FIG. 8, in operation 810, the content sharing apparatus 200 may generate the content.

In operation 812, the content sharing apparatus 200 may set an access control policy of the content, whether a comment is permissible, and whether an ID of a commenter is represented, and the like. In this example, the ID of the commenter may be used to identify a user sharing the comment.

In operation 814, the content sharing apparatus 200 may generate a content key that may be used to encrypt the generated content. In this example, the content key may be set in advance to be open to a predetermined group or an individual, or may be recognized by only a user that generates the content key, or may be published to only a predetermined user after encryption, and so on.

In operation 816, the encryption unit 234 of the content sharing apparatus 200 may encrypt the content using the content key.

In operation 818, the content sharing apparatus 200 may generate an ACL of the content.

In operation 820, the content sharing apparatus 200 may share the encrypted content, and the ACL of the content via the distributed network 100.

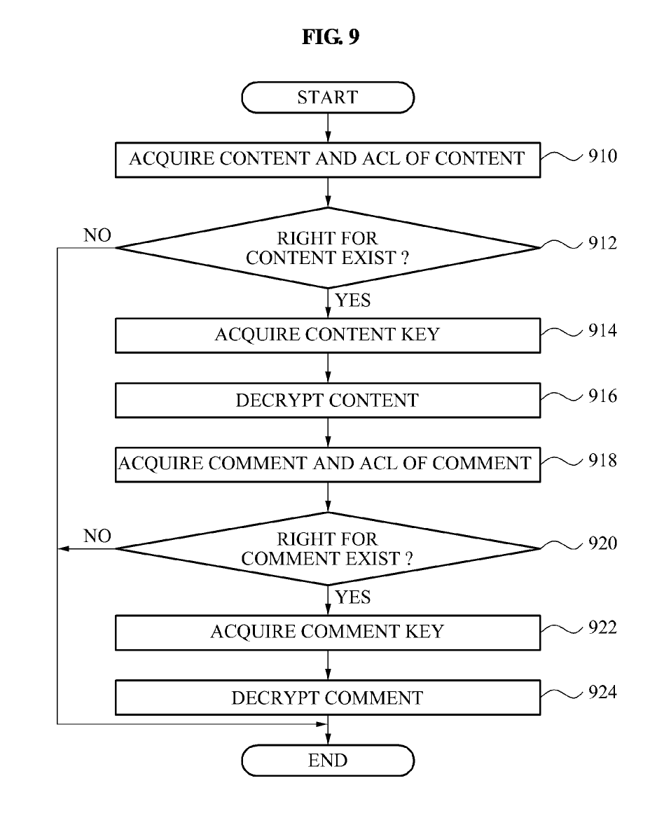

FIG. 9 is a flowchart illustrating an example of a method of requesting the content, and a comment on the content, and using the content and comment in the comment using apparatus 300.

Referring to FIG. 9, in operation 910, the comment using apparatus 300 may receive a comment request command, may verify a content name included in the received comment request command, may request the distributed network 100 to transmit the content corresponding to the content name, and an ACL of the content, and may acquire the content, and the ACL of the content.

In operation 912, the comment using apparatus 300 may determine whether a right for the content exists, by checking the ACL of the content

In response to the right for the content being determined to exist in operation 912, the comment using apparatus 300 may acquire a content key used to decrypt the content in operation 914.

In operation 916, the comment using apparatus 300 may decrypt the content using the content key.

In operation 918, the comment using apparatus 300 may request the distributed network 100 to transmit an ACL of the comment, and the comment on the content corresponding to at least one condition included in the comment request command, and may acquire the comment and the ACL of the comment.

In operation 920, the comment using apparatus 300 may verify an access control policy by checking a header of the comment, and may verify a right for the comment by checking the ACL of the comment.

In response to the right for the comment being determined to exist as a result of operation 920, the comment using apparatus 300 may acquire a comment key based on the access control policy. In this example, the comment key may be used to decrypt the comment in operation 922.

In operation 924, the comment using apparatus 300 may decrypt the comment using the comment key.

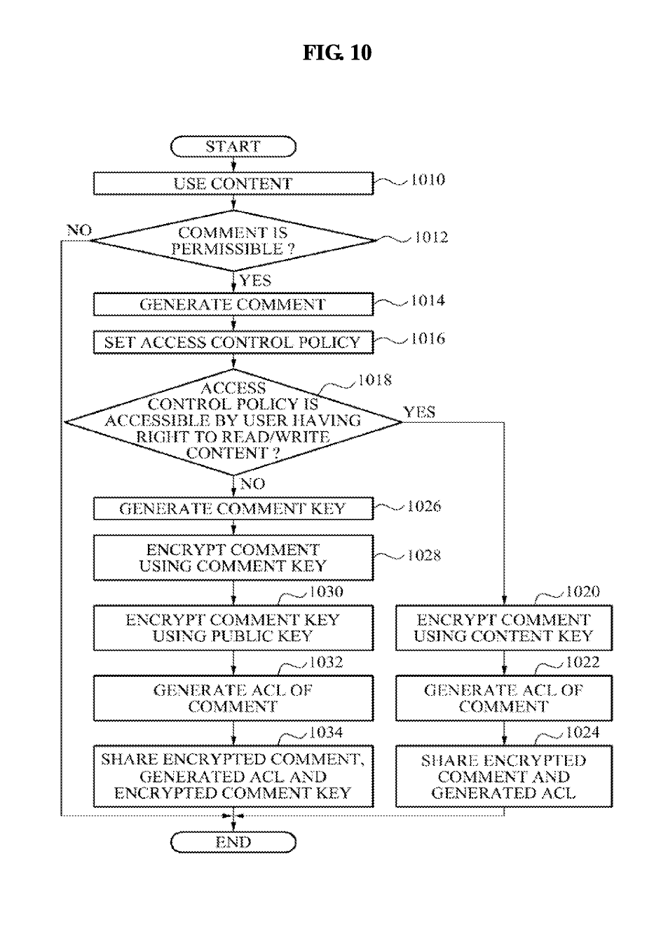

FIG. 10 is a flowchart illustrating an example of a method of generating a comment on content and sharing the comment in the comment sharing apparatus 400.

Referring to FIG. 10, in operation 1010, the comment sharing apparatus 400 may request the distributed network 100 to transmit content, and may use the content.

In operation 1012, the comment sharing apparatus 400 may determine whether generating a comment on the content is permissible.

In response to the comment being determined to be permissible in operation 1012, the comment sharing apparatus 400 may generate a comment on the content in operation 1014.

In operation 1016, the comment sharing apparatus 400 may set an access control policy for the comment.

In operation 1018, the comment sharing apparatus 400 may determine whether the access control policy is accessible by only a user having a right to read and write the content.

In a case in which it is determined that the access control policy is accessible by only the user having the right to read and write the content, the comment sharing apparatus 400 may encrypt the comment using a content key in operation 1020.

In operation 1022, the comment sharing apparatus 400 may generate an ACL of the comment.

In operation 1024, the comment sharing apparatus 400 may share the encrypted comment and the ACL of the comment via the distributed network 100.

Alternatively, in a case in which the access control policy is accessible by only a content sharer sharing the content, or in which the access control policy is accessible by only a content sharer sharing the content and a comment sharer sharing the comment, the comment sharing apparatus 400 may generate a comment key, or example, by using a random number, in operation 1026.

In operation 1028, the comment sharing apparatus 400 may encrypt the comment using the comment key generated in operation 1026.

In operation 1030, the comment sharing apparatus 400 may encrypt the comment key using a public key. More specifically, in an example in which the access control policy is accessible by only a content sharer sharing the content, the comment sharing apparatus 400 may encrypt the comment key using a public key of the content sharer. In another example in which the access control policy is accessible by only a content sharer sharing the content and a comment sharer sharing the comment, the comment sharing apparatus 400 may encrypt the comment key using a public key of the content sharer, and using a public key of the comment sharer.

In operation 1032, the comment sharing apparatus 400 may generate an ACL of the comment.

In operation 1034, the comment sharing apparatus 400 may share the encrypted comment, the ACL of the comment, and the encrypted comment key, via the distributed network 100.

Program instructions to perform a method described herein, or one or more operations thereof, may be recorded, stored, or fixed in one or more computer-readable storage media. The program instructions may be implemented by a computer. For example, the computer may cause a processor to execute the program instructions. The media may include, alone or in combination with the program instructions, data files, data structures, and the like Examples of computer-readable media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like Examples of program instructions include machine code, such as produced by a compiler, and files containing higher level code that may be executed by the computer using an interpreter. The program instructions, that is, software, may be distributed over network coupled computer systems so that the software is stored and executed in a distributed fashion. For example, the software and data may be stored by one or more computer readable recording mediums. Also, functional programs, codes, and code segments for accomplishing the example embodiments disclosed herein can be easily construed by programmers skilled in the art to which the embodiments pertain based on and using the flow diagrams and block diagrams of the figures and their corresponding descriptions as provided herein. Also, the described unit to perform an operation or a method may be hardware, software, or some combination of hardware and software. For example, the unit may be a software package running on a computer or the computer on which that software is running.

As a non-exhaustive illustration only, the apparatuses described herein may refer to mobile devices such as a cellular phone, a personal digital assistant (PDA), a digital camera, a portable game console, and an MP3 player, a portable/personal multimedia player (PMP), a handheld e-book, a portable lab-top PC, a global positioning system (GPS) navigation, and devices such as a desktop PC, a high definition television (HDTV), an optical disc player, a setup box, and the like capable of wireless communication or network communication consistent with that disclosed herein.

A computing system or a computer may include a microprocessor that is electrically connected with a bus, a user interface, and a memory controller. It may further include a flash memory device. The flash memory device may store N-bit data via the memory controller. The N-bit data is processed or will be processed by the microprocessor and N may be 1 or an integer greater than 1. Where the computing system or computer is a mobile apparatus, a battery may be additionally provided to supply operation voltage of the computing system or computer. It will be apparent to those of ordinary skill in the art that the computing system or computer may further include an application chipset, a camera image processor (CIS), a mobile Dynamic Random Access Memory (DRAM), and the like. The memory controller and the flash memory device may constitute a solid state drive/disk (SSD) that uses a non-volatile memory to store data.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus for using a comment on content, the apparatus comprising:
a content request unit to receive a comment request command, to verify a content name included in the received comment request command, to request a distributed network to transmit content corresponding to the content name, and an access control list (ACL) of the content, to acquire the content and the ACL of the content from the distributed network, and to verify a right for the content by checking the ACL of the content;
a content key acquisition unit to acquire a content key in response to the right for the content existing, the content key being used to decrypt the content;
a comment request unit to request the distributed network to transmit the comment on the content, and an ACL of the comment, to receive the comment and the ACL of the comment from the distributed network, to verify an access control policy by checking a header of the comment, and to verify a right for the comment by checking the ACL of the comment, the comment corresponding to at least one condition included in the comment request command;
a comment key acquisition unit to acquire a comment key based on the access control policy, in response to the right for the comment existing, the comment key being used to decrypt the comment; and
a decryption unit to decrypt the content using the content key, and to decrypt the comment using the comment key.

2. The apparatus of claim 1, wherein, in response to the access control policy being accessible by only a user having a right to read and write the content, the comment key acquisition unit acquires the content key as the comment key.

3. The apparatus of claim 1, wherein, in response to the access control policy being accessible by only a content sharer sharing the content, and in response to the content sharer requesting the comment, the comment key acquisition unit requests the distributed network to transmit a comment key encrypted with a public key of the content sharer, acquires the encrypted comment key from the distributed network, and decrypts the encrypted comment key using a private key of the content sharer, to obtain the comment key.

4. The apparatus of claim 1, wherein, in response to the access control policy being accessible by only a content sharer sharing the content and a comment sharer sharing the comment, and in response to the content sharer requesting the comment, the comment key acquisition unit requests the distributed network to transmit a comment key encrypted with a public key of the content sharer, acquires the encrypted comment key from the distributed network, and decrypts the encrypted comment key using a private key of the content sharer, to obtain the comment key.

5. The apparatus of claim 1, wherein, in response to the access control policy being accessible by only a content sharer sharing the content and a comment sharer sharing the comment, and in response to the comment sharer requesting the comment, the comment key acquisition unit requests the distributed network to transmit a comment key encrypted with a public key of the comment sharer, acquires the encrypted comment key from the distributed network, and decrypts the encrypted comment key using a private key of the comment sharer, to obtain the comment key.

6. The apparatus of claim 1, wherein the header of the comment comprises a name of the content, a content tag, a comment tag, and version information,
the content tag comprises information regarding whether a comment is permissible, and information regarding whether identification information of a comment sharer is included,
the comment tag comprises information indicating a start of comment-related information, information regarding whether a sub-comment is permissible, information regarding whether identification information of a sub-comment sharer is included, access control policy information, or any combination thereof, and
the version information comprises time information regarding a time at which the comment is shared.

7. The apparatus of claim 6, wherein the header of the comment further comprises the identification information of the comment sharer sharing the comment.

8. The apparatus of claim 1, wherein the comment request command comprises a command to request the content, and all comments corresponding to the content; a command to request the content, and a comment of a designated comment sharer among the comments; a command to request the content, and a comment corresponding to a designated time slot among the comments; a command to request the content, and a comment of a designated comment sharer in a designated time slot among the comments; or any combination thereof.

9. An apparatus for sharing a comment on content, the apparatus comprising:
a content using unit to request a distributed network to transmit the content, and to use the content;
a comment generation unit to generate the comment on the content, in response to the comment on the content being permitted;
a policy setting unit to set an access control policy for the comment;
a comment key generation unit to generate a comment key based on the access control policy;
an encryption unit to encrypt the comment using the comment key, and to share the encrypted comment via the distributed network; and
a comment access control list (ACL) generation unit to generate an ACL of the comment, and to share the generated ACL via the distributed network.

10. The apparatus of claim 9, wherein the comment generation unit verifies a content tag included in a header of the content, and determines whether the comment is permissible.

11. The apparatus of claim 9, wherein the policy setting unit sets the access control policy based on a preset criterion, or sets the access control policy in response to an input of a user.

12. The apparatus of claim 9, wherein the policy setting unit inserts the access control policy into a header of the comment.

13. The apparatus of claim 9, wherein, in response to the access control policy being accessible by only a user having a right to read and write the content, the comment key generation unit uses, as the comment key, a content key used to decrypt the content.

14. The apparatus of claim 9, wherein, in response to the access control policy being accessible by only a content sharer sharing the content, the comment key generation unit generates the comment key using a random number, encrypts the comment key using a public key of the content sharer, and shares the encrypted comment key via the distributed network.

15. The apparatus of claim 9, wherein, in response to the access control policy being accessible by only a content sharer sharing the content and a comment sharer sharing the comment, the comment key generation unit generates the comment key using a random number, encrypts the comment key using a public key of the content sharer and using a public key of the comment sharer, and shares the encrypted comment keys via the distributed network.

16. The apparatus of claim 9, wherein the comment comprises a name of the content, a content tag, a comment tag, and version information,
the content tag comprises information regarding whether a comment is permissible, and information regarding whether identification information of a comment sharer is included,
the comment tag comprises information indicating a start of comment-related information, information regarding whether a sub-comment is permissible, information regarding whether identification information of a sub-comment sharer is included, access control policy information, or any combination thereof, and
the version information comprises time information regarding a time at which the comment is shared.

17. The apparatus of claim 16, wherein the header of the comment further comprises the identification information of the comment sharer sharing the comment.

18. A method of using a comment on content in a comment using apparatus, the method comprising:
verifying a content name in response to a comment request command, the content name being included in the received comment request command;
requesting a distributed network to transmit the content corresponding to the content name, and an access control list (ACL) of the content, and acquiring the content and the ACL of the content from the distributed network;
verifying a right for the content by checking the ACL of the content;
acquiring a content key in response to the right for the content existing, the content key being used to decrypt the content;
decrypting the content using the content key;
requesting the distributed network to transmit a comment on the content, and an ACL of the comment, and receiving the comment and the ACL of the comment from the distributed network, the comment corresponding to at least one condition included in the comment request command;
verifying an access control policy by checking a header of the comment, and verifying a right for the comment by checking the ACL of the comment;
acquiring a comment key based on the access control policy, in response to the right for the comment existing, the comment key being used to decrypt the comment; and
decrypting the comment using the comment key.

19. A method of sharing a comment on content in a comment sharing apparatus, the method comprising:
requesting a distributed network to transmit the content, and using the content;
generating the comment on the content, in response to the comment on the content being permitted;
setting an access control policy for the comment;
generating a comment key based on the access control policy;
encrypting the comment using the comment key, to obtain the encrypted comment;
generating an access control list (ACL) of the comment; and
sharing the encrypted comment, and the generated ACL via the distributed network.

20. The method of claim 19, wherein the generating of the comment key comprises:
using, as the comment key, a content key used to decrypt the content, in response to the access control policy being accessible by only a user having a right to read and write the content.

21. The method of claim 19, wherein the generating of the comment key comprises, in response to the access control policy being accessible by only a content sharer sharing the content:
generating the comment key using a random number;
encrypting the comment key using a public key of the content sharer; and
sharing the encrypted comment key via the distributed network.

22. The method of claim 19, wherein the generating of the comment key comprises, in response to the access control policy being accessible by only a content sharer sharing the content and a comment sharer sharing the comment:
generating the comment key using a random number;
encrypting the comment key using a public key of the content sharer and using a public key of the comment sharer; and
sharing the encrypted comment keys via the distributed network.

23. A method of generating and sharing content, the method comprising:
generating the content;
setting an access control policy of the content;
encrypting the content;
generating an access control list (ACL) of the content; and
sharing the encrypted content and the generated ACL.

24. The method of claim 23, wherein the encrypting of the content comprises generating a content key and encrypting the content using the content key.

25. The method of claim 24, wherein the content key is used as a comment key to indicate whether a comment is allowed on the content.

26. The method of claim 23, wherein the ACL indicates whether a user has a right to read, write, and/or delete the content.

27. The method of claim 23, further comprising generating a header for the content, wherein the header indicates whether a comment is permissible.
